(19) United States
(12) Patent Application Publication
(10) Pub. No.: US 2026/0307938 A1
(43) Pub. Date: Oct. 8, 2026

(54) GATEWAY FOR CONTROLLING ELEVATOR CONNECTIVITY

(71) Applicant: KONE Corporation, Helsinki (FI)

(72) Inventor: Juan Pamanes, Helsinki (FI)

(73) Assignee: KONE Corporation, Helsinki (FI)

(21) Appl. No.: 19/171,057

(22) Filed: Apr. 4, 2025

(51) Int. Cl. B66B 1/34; B66B 1/46; B66B 5/00

(52) U.S. Cl. CPC B66B 1/3407; B66B 1/3461; B66B 1/468; B66B 5/0012; B66B 2201/463; B66B 2201/4653

(57) ABSTRACT

An elevator system includes an elevator, an elevator controller, a gateway, and a triggering device. The elevator is configured to move in an elevator shaft. The elevator controller is configured to control the movement of the elevator in the elevator shaft based on received requests. The gateway includes an internet connection, the gateway being configured to communicate via the internet connection for emergency elevator services and non-emergency elevator services. The triggering device includes a connectivity switch, the triggering device being connected to the gateway using a first non-internet connection, the connectivity switch being operable manually, the triggering device being configured to communicate a disable command to the gateway via the first non-internet connection in response to the connectivity switch being set to a disable position. The gateway is configured to disable internet communication related to non-emergency elevator services including the non-emergency elevator services in response to receiving the disable command.

### BACKGROUND

Recent regulations in the United States of America require that elevators that are connected to the internet and to an elevator controller, or any elevator controller connected to the internet must provide a manual means on-site to disable the connectivity, except for connectivity pertaining to emergency communications. The rationale for this requirement is to provide means for authorized and emergency personnel to disable connectivity and ensure no external systems can interact with the equipment when they are performing an activity with the Elevator.

To comply with this regulation, some elevators are being equipped with manual hardware disconnection devices which allow for communication devices to be manually disconnected from the internet. This approach requires separate or duplicate hardware to maintain connection for emergency communications.

### SUMMARY

Example embodiments of the present disclosure relate to an apparatus which uses a manual input to modify data processing of data packets so that data packets are discarded which do not related to emergency services. The example embodiments cause the apparatus to comply with elevator control regulations while not requiring a separate or duplicate system for emergency communications. Consequently, existing elevators can be easily updated, new elevators do not require duplicate systems and overall cost of complying with the regulation can be reduced. These improvements come from several features in the below described example embodiments.

In an example embodiment, an elevator system includes an elevator, an elevator controller, a gateway, and a triggering device. The elevator is configured to move in an elevator shaft. The elevator controller is configured to control the movement of the elevator in the elevator shaft based on received requests. The gateway includes an internet connection, the gateway being configured to communicate via the internet connection for emergency elevator services and non-emergency elevator services. The triggering device includes a connectivity switch, the triggering device being connected to the gateway using a first non-internet connection, the connectivity switch being operable manually, the triggering device being configured to communicate a disable command to the gateway via the first non-internet connection in response to the connectivity switch being set to a disable position. The gateway is configured to disable internet communication related to non-emergency elevator services including the non-emergency elevator services in response to receiving the disable command and maintain internet communication related to the emergency elevator services in response to the internet communication related to non-emergency elevator services being disabled.

In another example embodiment a gateway includes processing circuitry configured to communicate with an elevator controller via a first non-internet connection, communicate in a first mode over an internet connection for emergency elevator services and non-emergency elevator services, communicate in a second mode over the internet connection for the emergency elevator services, in the second mode communications for the non-emergency elevator services being restricted, and switch between the first mode and the second mode in response to receiving a disable command from a trigger device via a second non-internet connection.

In another example embodiment, a method of controlling a gateway in an elevator system includes communicating with an elevator controller via a first non-internet connection, communicating in a first mode over an internet connection for emergency elevator services and non-emergency elevator services, communicating in a second mode over the internet connection for the emergency elevator services, in the second mode communications for the non-emergency elevator services being restricted, and switching between the first mode and the second mode in response to receiving a disable command from a trigger device via a second non-internet connection.

### BRIEF DESCRIPTION OF THE DRAWINGS

The drawings illustrate example embodiments which provide improvements over the prior art. The drawings include the following:

FIG. 1A illustrates an example embodiment of an elevator control system when a manual connectivity switch is set to disabled.

FIG. 1B illustrates an example embodiment of an elevator control system processing data packets while the manual connectivity switch is set to disabled;

FIG. 1C illustrates an example embodiment of an elevator control system processing data packets while the manual connectivity switch is set to enabled;

FIG. 2 illustrates an elevator system in a building according to an example embodiment; and

FIG. 3 illustrates a block diagram of a gateway device according to an example embodiment.

### DETAILED DESCRIPTION OF THE DRAWINGS

The detailed description of the drawings provides example embodiments which illustrate advantages over the prior art. The example embodiments should not be interpreted as exclusive. The example features described below should not be interpreted as necessary features unless expressly described as such.

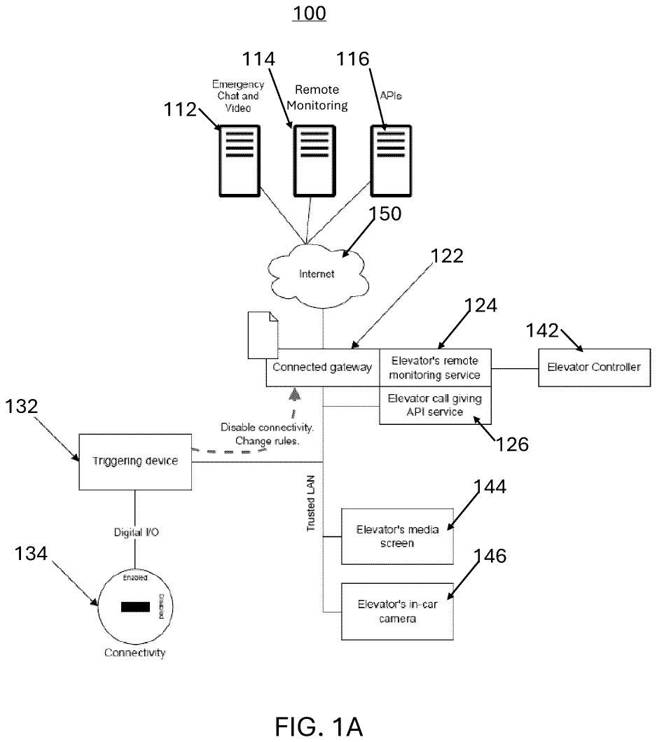

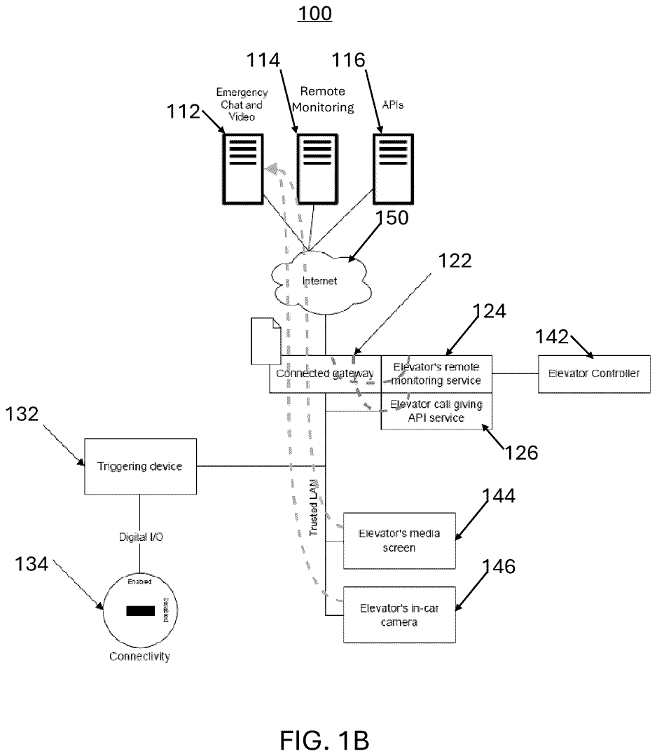

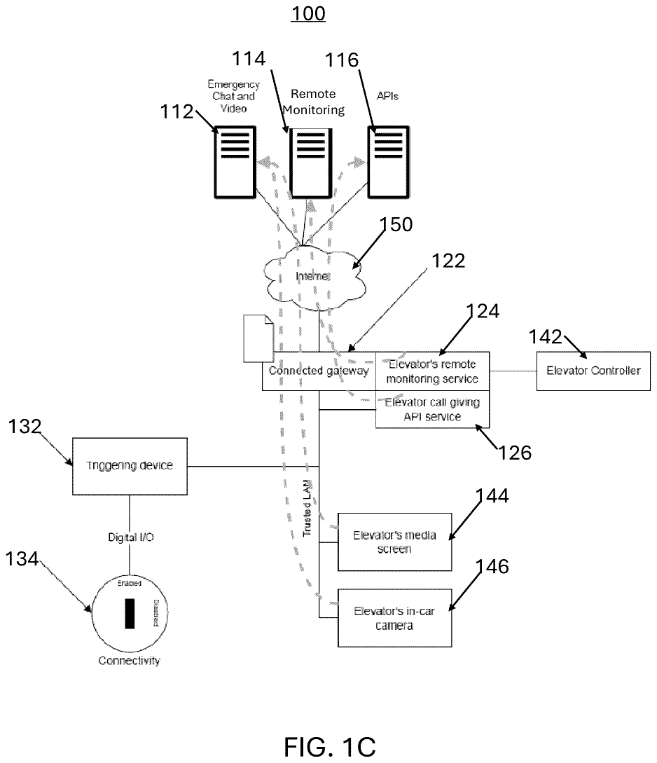

FIG. 1A illustrates an example embodiment of an elevator system 100 when a manual connectivity switch 134 is set to disabled. The elevator control system 100 may include a gateway 122 connected to an elevator's remote monitoring service 124, elevator call giving API (application programming interface) 126, elevator controller 142, elevator's media screen 144, elevator's in-car camera 146, triggering device 132 and connectivity switch 134. The gateway 122 may also be connected to the internet 150 and via the internet 150 (e.g., via an internet connection) connected to an emergency chat and video server (emergency server) 112, remote monitoring server 114, and APIs server 116. The gateway 122 may be the only portion of the elevator control system 100 connected directly to the internet. The gateway 122 is configured to communicate via the internet connection for emergency elevator services and non-emergency elevator services.

The Elevator's remote monitoring service 124 may be implemented in processing circuitry to process information related to remote monitoring services. Remote monitoring services may include a remote video feed of the elevator's in-car camera 144, which is in an elevator car, remote access to elevator information such as a location of the elevator (e.g., a floor where the elevator is currently located), or other information about an elevator car.

The elevator call giving API 126 may be implemented in processing circuitry and may control communications of requests for elevator movement to the elevator controller 142. The requests for elevator movement may be local (e.g., calls at buttons in elevator lobbies) or remote (e.g., received via the gateway through the internet 150). The elevator call giving API 126 may receive requests for elevator movement and send the requests to the elevator controller 142. The elevator call giving API 126 may also communicate with the APIs server 116 via the gateway 122.

The elevator controller 142 may be implemented in processing circuitry and may control the movement of the elevator by controlling elevator doors, an elevator winch, and other elevator hardware which moves the elevator. The elevator controller 143 may receive requests for movement of the elevator from the elevator call giving API service 126 and control the movement of the elevator based on the requests for movement.

The elevator's media screen 144 is a display device which may include a display, speaker, and a user input device such as a touch screen and microphone. The elevator's media screen 144 may display advertisements managed by the APIs server 116. The advertisements may be sent by the APIs server 116 in information packets that are sent through the internet via the gateway 122. The elevator's media screen 144 may display the elevator's current floor, emergency announcements, or other information related to the elevator's operation. The elevator's media screen 144 may also provide audio output through the speaker.

The elevator's in-car camera 146 may be a video recording device which transmits a live video stream of the interior of the elevator car to the gateway 112, to security in the building, and other authorized locations. A live or delayed video feed may be transmitted by the gateway to the Emergency chat and video server 112 via the internet 150.

The emergency chat and video server (emergency server) 112 may be a server outside of the building including the elevator which manages emergency services including emergency video feed and audio communications. The emergency video feed may be the live video feed from the elevator's in-car camera 146. The emergency chat may be dialog through the display or speaker of the elevator's media screen 144.

The remote monitoring server 114 may be a server outside the building including the elevator which manages non-emergency elevator services such as remote video monitoring and maintenance related services and monitoring. Data from the elevator's remote monitoring service 124 related to the operation of the elevator and data from the elevator's in-car camera 146 may be transmitted to the remote monitoring server 114 over the internet via the gateway 122.

The APIs server 116 communicates with the gateway 122 over the internet 150 to manage non-emergency elevator services such as remote application program interface services including remote requests for elevator movement. The API's server 116 may communicate with user's devices such as smartphones to receive requests for an elevator movement to pick up a user at a certain floor, the API's server 116 may process the requests and send a data packet including the request to the elevator's call giving API service 126 over the internet 150 via the gateway 122. The APIs server 116 may send packets related to advertisements to be displayed on the elevator's media screen and communicate with advertiser devices related to these services. The APIs server 116 may also manage a service for remote video view of the elevator, the video feed of the elevator's in-car camera 146 may be delayed (e.g., buffered).

The connectivity switch 134 may be included in the triggering device 132. The connectivity switch 134 may be manually operable and have an enabled position and a disabled position. The triggering device 132 may include processing circuitry which when the connectivity switch 134 is switched sends a signal to the gateway 122. The triggering device 132 may be connected to the gateway via a non-internet connection. The triggering device 132 may be configured to send a disable command when the connectivity switch 134 is switched to the disable position, and an enable command, when the connectivity switch 134 is switched to the enable position. The disable command includes instructions to restrict internet communication. The enable command includes instructions to not restrict internet communication.

When the connectivity switch 134 is switched from enabled to disabled, the triggering device 132 may send a disable connectivity message (disable command) to change data transfer rules to the gateway 122 via a wired connection. The transfer rules at the gateway 122 may then be changed to discard any packets going to or from any server which is not related to emergency services via the internet 150. The rule changes may not apply to local communications over wired connections in the building with the elevator. For example, data packets or other information which are to be transferred to or are received from the remote monitoring server 114 and APIs server 116 are discarded by the gateway 122 and not forwarded to the intended destination. For example, remote requests for movement of the elevator are discarded. Data packets or other information related to emergency services are forwarded to their intended destination by the gateway 122. The rules change does not change rules for forwarding data packets or other information related to emergency services. The gateway may determine if a data packet or other information is related to emergency services based on a destination address or addressee in a header of the data packet. The information packet may also have an indication of being related to emergency services in the header of the data packet. The gateway 122 may store in a memory addresses of emergency service servers such as the emergency chat and video server 112 to make these determinations. The operation of the gateway 122 in a first mode is operating without the rule change where there is no restriction on data packets or other information being sent or received for non-emergency services. The operation of the gateway in the second mode is operating with the rule change where there is a restriction on data packets or other information being sent or received for non-emergency services.

FIG. 1B illustrates an example embodiment of an elevator control system 100 processing data packets while the manual connectivity switch 134 is set to disabled. When the switch is set to disabled, the gateway 122 operates in the second mode and data packets for the elevator are discarded which are not related to emergency services. For example, as shown in dotted lines, a data packet from the elevator's remote monitoring service 124 addressed to the remote monitoring server 114 is discarded by the gateway 122. Also, a packet from the elevator call giving API service 126 addressed to the APIs server 116 is discarded by the gateway 122. However, data packets from the elevator's media screen 144 and elevator's in car camera 146 are not discarded by the gateway and are forwarded via the internet 150 to the emergency chat and video server 112 because the emergency chat and video server's 112 address is saved in the memory as related to emergency services.

FIG. 1C illustrates an example embodiment of an elevator control system 100 processing data packets while the manual connectivity switch 134 is set to enabled. When the switch is set to enabled, the triggering device 132 sends the enable command and the gateway 122 operates in the first mode, in which data packets are not discarded which are not related to emergency services. For example, as shown in dotted lines, a data packet from the elevator's remote monitoring service 124 addressed to the remote monitoring server 114 is forwarded by the gateway 122 via the internet 150 to the remote monitoring server 114. Also, a packet from the elevator call giving API service 126 addressed to the APIs server 116 is forwarded by the gateway 122 via the internet 150 to the APIs server 116. Data packets from the elevator's media screen 144 and elevator's in car camera 146 are also via the internet 150.

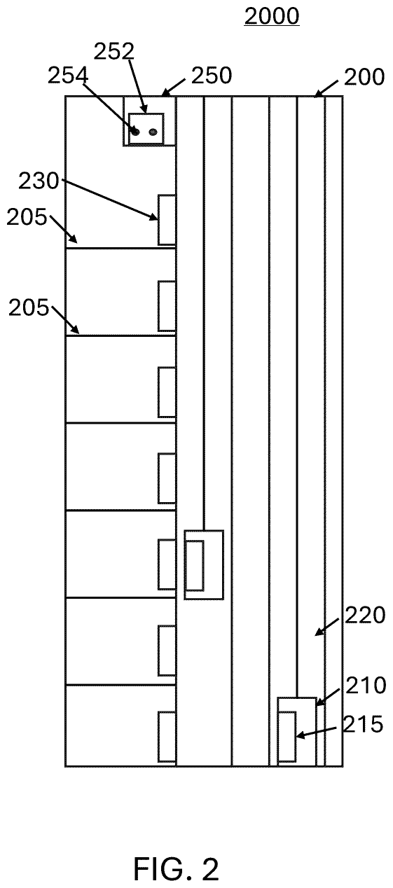

FIG. 2 illustrates an elevator system 200 in a building 2000 according to an example embodiment. The elevator system 200 may include elevator cars 210 operating in elevator shafts 220 in the building 200. The elevator cars 210 may include elevator car electronics 215. The elevator car electronics 215 may include the elevator car′ in-car camera 146 and elevator's media screen 144. The elevator car electronics 215 may also include control circuitry for controlling functions of the elevator car such as opening and closing elevator doors, selecting a floor to travel to, lighting, and air circulation. The elevator system may also include elevator call panels 230 at each elevator lobby 205 on each floor of the building 2000. The elevator call panels 230 may include buttons for requesting movement of the elevator 210. The building 2000 may include a control room 250 including elevator control circuitry 252. The elevator control circuitry 252 may include manual switches 254. The manual control switches may include a connectivity switch 134 for each elevator car 210 in the building 2000. Thus, the connectivity for each elevator may be controlled individually. For example, if the building 2000 includes two elevators and the connectivity switch 134 for the first elevator is set to disabled and the connectivity switch for the second elevator is set to enabled, the gateway 122 will only discard packets related to non-emergency services for the first elevator and not for non-emergency services for the second elevator. The manual switches 254 may also include switches for manually cutting power to the elevators or other elevator related manual switching.

The elevator control circuitry 252 may include processing circuitry which includes the gateway 122, elevator call giving API service 126, elevator remote monitoring service 124, elevator controller 142, and triggering device 132. The elevator control circuitry 252 may include servers, processors, memories, and telecommunication hardware capable of communicating locally and via the internet. The elevator control circuitry 252 may include non-internet connections between the gateway 122, elevator call giving API service 126, elevator remote monitoring service 124, elevator controller 142, and triggering device 132, such as wired connections between processors, memories, servers, and other processing circuitry.

The elevator system 200 also includes elements not shown such as motors for moving the elevator cars 210, electrical wires between the various systems for electronic communication, counter weights, brakes, electrical power sources, elevator doors, elevator lobby doors, and other hardware for the operation of the elevator system.

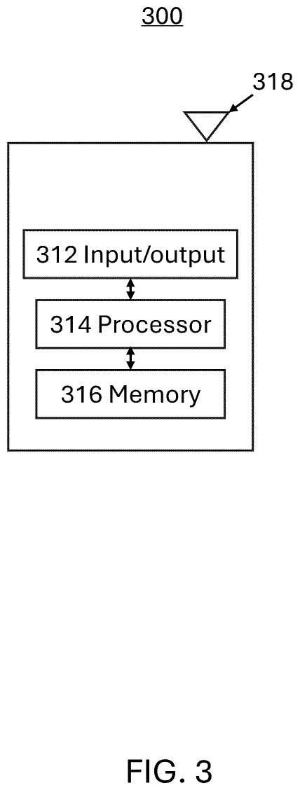

FIG. 3 illustrates a block diagram of a gateway device 300 according to an example embodiment. The gateway device 300 may be a computer, controller, server, group of processing devices, etc. The gateway device 300 may include input and output hardware 312 a processor 314, a memory 316, and communication hardware 318. The input and output 312 hardware may include a monitor, touch screen, speaker, camera, microphone, keyboard, mouse, printer, facsimile machine, and other similar hardware for interacting with a human user. The processor 314 may be any type of electronic processing hardware, such as central processing unit, programmable controller, field programmable gate array, microprocessor, multicore processor, etc. The memory 314 may include both volatile and non-volatile memory. The memory 316 may include a non-transitory computer readable medium. The processor 314 and memory 316 together may be considered processing circuitry configured to perform processing operations such as executing instructions stored in the memory 316. The communication hardware 318 may include wired and wireless communication hardware for communication via internet connection and non-internet connections. The communication hardware 318 may include ports for wired communication, antenna for wireless communication, optical terminals for fiber optic communication, and other similar hardware.

The gateway device 300 may communicate over wireless local area network, cell phone network, device to device communication, wired communication, fiber optic communication or any other form of electronic communication.

Various embodiments described herein may be implemented in a computer-readable medium using, for example, software, hardware, or some combination thereof. For a hardware implementation, the embodiments described herein may be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure.

For a software implementation, the embodiments such as procedures and functions may be implemented together with separate software modules each of which performs at least one of functions and operations. The software codes can be implemented with a software application written in any suitable programming language. Also, the software codes may be stored in the memory and executed by the controller. Thus, the components shown in the drawings have sufficient structure to implement the appropriate algorithms for performing the described functions.

The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention.

What is claimed is:

1. An elevator system comprising:
an elevator configured to move in an elevator shaft;
an elevator controller configured to control the movement of the elevator in the elevator shaft based on received requests;
a gateway including an internet connection, the gateway being configured to communicate via the internet connection for emergency elevator services and non-emergency elevator services; and
a triggering device including a connectivity switch, the triggering device being connected to the gateway using a first non-internet connection, the connectivity switch being operable manually, the triggering device being configured to communicate a disable command to the gateway via the first non-internet connection in response to the connectivity switch being set to a disable position,
wherein the gateway is configured to disable internet communication related to non-emergency elevator services including the non-emergency elevator services in response to receiving the disable command and maintain internet communication related to the emergency elevator services in response to the internet communication related to non-emergency elevator services being disabled.

2. The elevator system of claim 1 wherein,
the requests include local requests and remote requests for movement of the elevator,
the non-emergency elevator services include receiving the remote requests; and
in response to the internet communication related to the non-emergency elevator services being disabled by the gateway, the gateway is configured to not forward the remote requests to the elevator controller.

3. The elevator system of claim 1, wherein,
the gateway determines whether a communication over the internet connection is for emergency elevator services based on a header of data packets included in the communication.

4. The elevator system of claim 1, wherein
the gateway determines whether a communication over the internet connection is for emergency elevator services based on an addressee or address included in the communication.

5. The elevator system of claim 1, wherein
the gateway and the elevator controller are connected via a second non-internet connection.

6. The elevator system of claim 1, wherein
the elevator includes an in-car camera, and
the emergency elevator services include transmitting a video output of the in-car camera to an emergency elevator service server via the internet connection.

7. The elevator system of claim 1, further comprising:
a plurality of elevators including the elevator; and
a plurality of connectivity switches including the connectivity switch, wherein each of the connectivity switches corresponds to a respective one of the plurality of elevators to control sending of a plurality of respective disable commands to each of the plurality of elevators, the plurality of disable commands including the disable command.

8. The elevator system of claim 7, wherein
the requests include local requests and remote requests for movement of the plurality of elevators,
the non-emergency elevator services include receiving the remote requests, and
in response to the internet communication related to the non-emergency elevator services being disabled by the gateway for one of the plurality of elevators, the gateway is configured to not forward the remote requests to the elevator controller.

9. The elevator system of claim 1, wherein
the triggering device is configured to communicate an enable command to the gateway via the first non-internet connection in response to the connectivity switch being set to an enabled position.

10. The elevator system of claim 1, wherein
the non-emergency elevator services include a remote monitoring elevator service, and
in response to the internet communication related to the non-emergency elevator services being disabled by the gateway, the gateway is configured to not forward information related to the remote monitoring elevator service via the internet connection.

11. A gateway comprising:
processing circuitry configured to:
communicate with an elevator controller via a first non-internet connection;
communicate in a first mode over an internet connection for emergency elevator services and non-emergency elevator services;
communicate in a second mode over the internet connection for the emergency elevator services, in the second mode communications for the non-emergency elevator services being restricted; and
switch between the first mode and the second mode in response to receiving a disable command from a trigger device via a second non-internet connection.

12. The gateway of claim 11 wherein,
the non-emergency elevator services include receiving remote requests for movement of the elevator; and
in a second mode, the processing circuitry is configured to not forward the remote requests to the elevator controller.

13. The gateway of claim 11, wherein,
the processing circuitry determines whether a communication over the internet connection is for emergency elevator services based on a header of data packets included in the communication.

14. The gateway of claim 11, wherein
the gateway determines whether a communication over the internet connection is for emergency elevator services based on an addressee or address included in the communication.

15. The gateway of claim 11, wherein
the emergency elevator services include transmitting a video output of an in-car camera of the elevator to an emergency elevator service server by the gateway via the internet connection.

16. A method of controlling a gateway in an elevator system comprising:
communicating with an elevator controller via a first non-internet connection;
communicating in a first mode over an internet connection for emergency elevator services and non-emergency elevator services;
communicating in a second mode over the internet connection for the emergency elevator services, in the second mode communications for the non-emergency elevator services being restricted; and
switching between the first mode and the second mode in response to receiving a disable command from a trigger device via a second non-internet connection.

17. The method of claim 11 wherein,
the non-emergency elevator services include receiving remote requests for movement of the elevator; and
in a second mode, the gateway is configured to not forward the remote requests to the elevator controller.

18. The method of claim 11, wherein,
the gateway determines whether a communication over the internet connection is for emergency elevator services based on a header of data packets included in the communication.

19. The method of claim 11, wherein
the gateway determines whether a communication over the internet connection is for emergency elevator services based on an addressee or address included in the communication.

20. The method of claim 11, wherein
the emergency elevator services include transmitting a video output of an in-car camera of the elevator to an emergency elevator service server by the gateway via the internet connection.
